(19) United States
(12) Patent Application Publication
(10) Pub. No.: US 2011/0080489 A1
(43) Pub. Date: Apr. 7, 2011

(54) PORTRAIT PHOTO ASSISTANT

(75) Inventors: Leon Chen, Taipei (TW); Max Yu, Taipei (TW); David Lu, Taipei (TW); Araya Bethlehem, Taipei (TW)

(73) Assignee: SONY ERICSSON MOBILE COMMUNICATIONS AB, Lund (SE)

(21) Appl. No.: 12/572,359

(22) Filed: Oct. 2, 2009

(51) Int. Cl. G06K 9/46; H04N 5/228

(52) U.S. Cl. 348/222.1; 382/195; 348/E05.031

(57) ABSTRACT

The present invention describes an image capturing device and a method for image capturing in an auto-portrait situation, where the image capturing device determines whether the face of the user who is making the auto-portrait is positioned in desired way a preferred area of the image capturing device. In order for the auto-portrait to be satisfactory criteria regarding the distance and the size of the user's face in the preferred area have to be fulfilled. A processing unit in the image capturing device gives feedback to the user based on how far or how near the face of the user is to the desired position and size in relation to the preferred area on the image capturing device. Once the criteria of the user's face regarding distance and size are fulfilled, the processing unit instructs a control unit in the image capturing device to freeze the feedback to the user.

### TECHNICAL FIELD

The present invention is related to the field of image capturing. More specifically, it relates to a device and method for image capturing where at least a part of an object is to be positioned within a preferred area.

### BACKGROUND ART

Today in the field of photography many technologies exist which help the user to place focus on a certain area of an image, such as autofocus assistants. With today's digital camera technology, whether it is in a standalone digital camera or in a mobile terminal with a built-in camera function, it is also possible to place focus on a certain part of an image, such as a face of a person or even a smiling person by means of face recognition algorithms.

However, a problem arises with these systems, when for example a user is to make an auto-portrait of himself or a group of people and would like to place him/herself or several people and him/herself within the digital viewfinder of the digital camera. For lack of better solutions, the user is required to hold the digital camera towards him- or herself and guess at which position of the camera he or she would be completely within the viewfinder.

Often, such actions do not succeed at first attempt and have to be repeated several times and checked by studying the photograph taken until they give a satisfactory result.

Sometimes the user has to move his camera far away from him- or herself which often results in the user appearing completely within the digital viewfinder of the camera, but in a rather small size to be really useful as an auto-portrait. This becomes even more pronounced when two or more people are to be photographed and desire to be seen completely within the digital viewfinder of the camera.

In digital cameras where the digital viewfinder is movable out of the camera housing (a so called swivel viewfinder) and may be rotated towards the user, the problem of making large enough auto-portraits which fit into the digital viewfinder is somewhat solved. However, manufacturing of such cameras is more costly than producing the standard built-in digital viewfinder cameras. Moreover, there are even less mobile terminals available who have the swivel function on the digital viewfinder available mainly due to the production cost size constraints of such an image capturing device.

Hence there is a need for a solution that always results in the face or head of the user or of the user and other people in an auto-portrait to be within a predefined area of the digital viewfinder and filling that area. Moreover, there is a need to eliminate the necessity to take several pictures with the camera and examine the picture with the preview function of the camera and at the same time to prevent the head or face of the user and/or other people being too small. Last but not least it would be advantageous if this could be achieved in an efficient and cost-effective way.

### SUMMARY OF THE INVENTION

The present invention addresses at least some of the needs which are hitherto not fulfilled or not satisfactorily fullfiled by known technology.

Such a solution is provided by the features of independent claim 1.

The solution according to the present invention is directed to a 1 method for image capturing by means of an electronic device, where the method comprises the steps:
registering at least a part of an object to be positioned within a preferred area;
determining the position and the size of the object registered in relation to the preferred area;
producing feedback to a user of the electronic device in relation to the position and size of the object determined in relation to the preferred area;
adjusting the feedback to the user in relation to the change in position and size of the object with respect to the preferred area;
producing a signal to the user indicating that the object is within the preferred area and has the position and size required in relation to the preferred area and;
capturing the image of the object thus located.

The main advantage of the method according to the present invention is the simplicity with which a user can make an auto portrait without being forced to take several pictures and to double-check with the preview function of the image capturing device in order to establish whether the auto portrait was satisfactory or not. Especially the signal produced for the user which indicates whether the desired auto portrait situation has been achieved shortens the process of making a satisfactory auto portrait considerably.

In one embodiment of the present invention the method may further comprise the steps of:
detecting predefined features of the object
selecting a reference point within the predefined features and;
determining the distance between the reference point and a point in the preferred area. This way, the calculation of the distance between the user's face and the preferred area is facilitated. It may be said that a user himself may choose the size and shape of the preferred area.

One way of defining the position of the object required in relation to the preferred area is the position where the distance between reference point of the object and a centre point of the preferred area is located within a predefined interval.

One may also define the position of the object required in relation to the preferred area as the position where the distance between the reference point of the object and a second reference point of the preferred area is located within a predefined interval.

Additionally, one may define the required size of the object in relation to the preferred area as comprising a ratio between the overlapping area between the object and the preferred area and the area of the object itself as being located within a predefined interval.

In one embodiment of the present invention the signal is produced when essentially the entire object is located within the preferred area.

In another embodiment of the present invention the signal is produced when a predetermined size of the entire object is located within the preferred area.

Now, the object may comprise a face the user of the electronic device or a number of human faces of which one is the face of the user of the electronic device.

Another aspect of the present invention is directed to an electronic image capturing device comprising:
a processing unit adapted for registering the presence of at least part of an object in a preferred area on the image capturing device, the processing unit further being adapted for determining the position and size of the object registered in relation to the preferred area,
at least one indicator for producing feedback to a user of the electronic device depending on the position and size of the object registered in relation to the preferred area;
a control unit for instructing the indicator to produce feedback to a user of the electronic device in relation to the position and size object of the object registered with respect to the preferred area, the control unit being further adapted to instruct the indicator to adjust the feedback in relation to the change in position and size of the object in relation to the preferred area,
   wherein the control unit is further adapted to instruct the indicator to produce a signal to the user indicative of the object having a required position and size in relation to the preferred area.

The image capturing device may further comprise a user interface for adjusting the size of the preferred area.

In one embodiment of the image capturing device according to the present invention the indicator may comprise an optical signal, an acoustic signal or a tactile signal.

Also, another aspect of the present invention is related to a computer program product for image capturing by means of an electronic device, comprising instructions sets for:
registering at least a part of an object to be positioned within a preferred area;
determining the position and the size of the object registered in relation to the preferred area;
producing feedback to a user of the electronic device in relation to the position and size of the object in relation to the preferred area;
adjusting the feedback in relation to the change in position and size of the object with respect to the preferred area;
producing a signal to the user indicating that the object is within the preferred area and has the position and size required in relation to the preferred area and;
capturing an image of the object thus located.

### BRIEF DESCRIPTION OF THE DRAWINGS

FIG. 1 displays an image capturing device according to one embodiment of the present invention.

FIG. 2 displays the image capturing device from FIG. 1 during a auto portrait photo session.

FIG. 3 displays the image capturing device from FIG. 1 during another situation of a auto portrait session.

FIG. 4 displays the image capturing device from FIG. 1 during yet another situation of a auto portrait session.

FIG. 5 displays the image capturing device form FIG. 1 during another situation of a self portrait session.

FIG. 6 illustrates a flow chart setting out the steps of a method according to one embodiment of the present invention.

### DETAILED DESCRIPTION

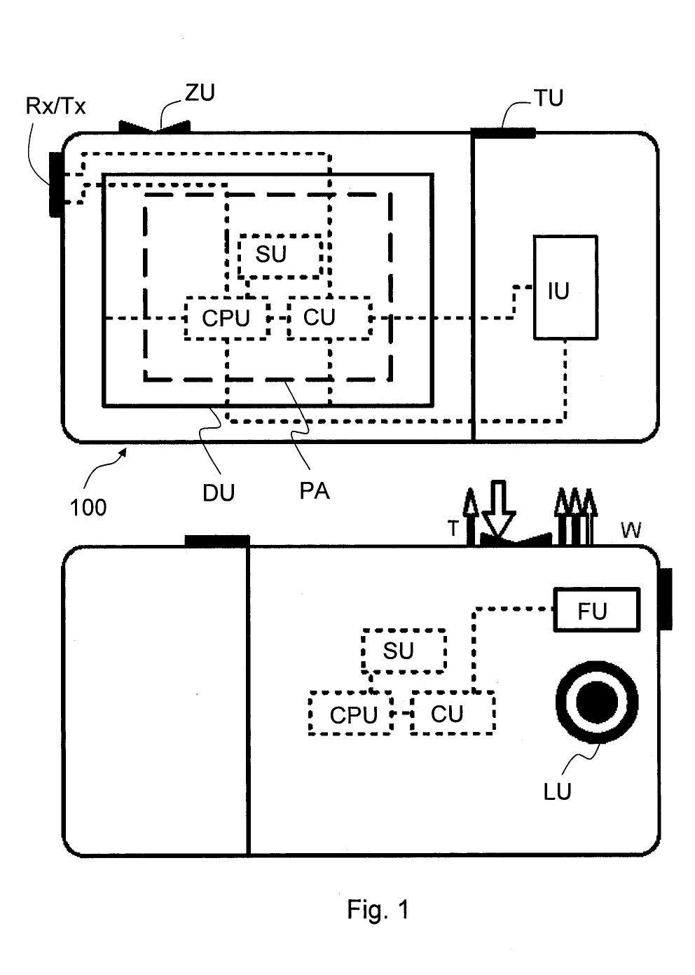

FIG. 1 displays an image capturing device 100 which in the embodiment displayed represents a mobile terminal. However, it should be mentioned that the mobile terminal is just one example of an image capturing device according to the present invention. It may equally be any other electronic device with image capturing capability, such as a digital compact—or SLR-camera, a media playing and capturing device and so on.

The upper part of FIG. 1 shows the front side of the image capturing device 100, while the lower part of FIG. 1 shows the backside of the same. It may be said that the front side of the image capturing device 100 in this embodiment is normally the side which a user sees when using the standard functions of a mobile terminal, such as dialling a number, using the music function or making pictures of objects seen through the digital viewfinder of the mobile terminal. It is also the side which a user sees when attempting to make a picture of objects in front of the image capturing device. In the event that the image capturing device is a digital camera or a digital SLR camera the front side visible in the upper part of FIG. 1 would simply the standard use situation when a user is attempting to photograph the environment and the objects around him. Likewise, in the event that the image capturing device is a media player or media capturing device it would be the normal use situation where the user is using the media functions of the device or capturing videos of the environment around him.

The backside is normally the side of the image capturing device 100 which the user sees when attempting to make a auto portrait photograph or when trying to make a picture of himself and other objects or people.

As can be seen from the figure, the image capturing device 100 comprises a receiver/transmitter unit Rx/Tx positioned at the top which has the usual functions of sending and receiving voice and data over a radio communication network. Such components are standard in any mobile terminal of today and will not be explained any further. However, the image capturing device 100 may also function without having any receiver/transmitter Rx/Tx.

Moreover, the image capturing device 100 also comprises an input unit IU which is used to input commands or characters for using the various functions of the image capturing device 100 and for sending and receiving messages over the wireless communication network in which the mobile terminal operates.

In principle, all electronic devices, whether they are mobile terminals or not, possess such an interface unit. A detailed description of the interface unit IU is therefore not necessary.

Additionally, the image capturing device 100 also comprises a lens unit LU, a zoom unit ZU and a trigger unit TU. It may be mentioned that the zoom unit ZU or TU may or may not be visible to the user from the outside. As in all electronic devices which have a camera function, pressing of the zoom unit has the effect of zooming in or zooming out of the area presently seen in a digital or optical viewfinder of the electronic device. In the image capturing device 100 of FIG. 1, the zooming directions are illustrated through the letters T as in tele for zooming in and W as in wide for zooming out.

Also, the lens unit may LU may comprise a simple fixed optic lens or a lens with zoom optics. Use of the zoom unit ZU may then result in a purely digital zoom or an optical zoom of the area seen in the digital viewfinder of the image capturing device 100.

Additionally, the image capturing device 100 also comprises a display unit for displaying among others the graphical user interface of the image capturing device 100 and also serve as a digital viewfinder of the lens unit LU. Normally, pressing or half-pressing of the trigger unit TU will force the image capturing device 100 into the camera mode and transform the display unit DU into a digital viewfinder for the camera function of the image capturing device 100.

One part of the display unit DU when used as a digital viewfinder in the camera mode is made up of a preferred area PA shown in dashed lines which has the function of serving as the area in which an object to be photographed is to be located. As is standard in many image capturing devices, pressing—or half-pressing the trigger unit TU will activate the auto-focus function of the image capturing device 100 and once the object to be photographed is within the preferred area PA and sharp, the preferred PA may change colour and an acoustical signal may be produced. Thus, it may be indicated to the user that the object is sharp and that a picture of the object can be made.

Moreover, indicated by small dashed lines in FIG. 1, the image capturing device 100 also comprises a processing unit CPU, a sensor unit SU and a control unit CU.

As is seen from the figure and indicated by a dashed line, the processing unit CPU is connected to the receiver/transmitter unit Rx/Tx for sending and receiving data provided by the user of the image capturing device 100 or sent to the image capturing device 100 by other users in the wireless communication network in which the terminal 100 is operating. However, as mentioned before, the presence of the receiver/transmitter unit Rx/Tx is not required for the present invention to function.

Also, the processing unit CPU is connected to a sensing unit SU which is adapted to register optical data passing through lens unit LU and convert the data into digital signals which can be processed further by the processing unit CPU. Besides the operations of conversion of raw image data from the sensing unit SU into a raw image format or a compressed image format, the processing unit CPU according to the present invention is also adapted to perform face and/or smile recognition algorithms on objects registered by the sensing unit SU via the optics of the lens unit LU. In this way, the processing unit CPU of the present invention can detect whether an object to be photographed is a human face and calculate how far from a center point of the preferred area PA the face is located as well as how big an area of the preferred area the face recognized covers. Of course, these algorithms can also be executed only when the face recognized is also recognized as a smiling face.

Depending on whether the face is nearing the center of the preferred area PA or distancing itself from it, as well as whether the area covered by the face is greater than the preferred area PA or not, the processing unit CPU is adapted to instruct a control unit CU to increase or decrease a feedback signal supplied by a feedback unit FU of the image capturing device 100. This feedback signal is intended for a user trying to make a auto portrait photograph of himself or himself and other objects or people.

It may be said here that the feedback signal produced by the feedback unit FU may either be an optical signal in which case the feedback unit FU may be a lamp or an acoustic signal. In the latter case, the feedback unit FU may be either a separate alarm unit or be connected to a sound output unit of the image capturing device 100 which normally is present in standard mobile terminals 100.

Furthermore, the processing unit CPU may instruct the control unit CU to increase or decrease the size of the preferred area PA as a result of user input through the interface unit IU. Also, the processing unit CPU may instruct the control unit CU to set a point in the preferred area PA as a result of a user selection through the interface unit IU. This point will then serve as the point in the preferred area PA to which the distance from an object such as the face of the user making an auto-portrait will be calculated.

It may also be mentioned that the processing unit CPU is adapted to react to the pressing of the zoom unit ZU and thereafter instruct the control unit CU to either digitally enlarge the image seen in the display unit DU when in camera mode or to enlarge it by moving the optics of the lens unit LU forward or backward—in case the lens unit LU comprises a zoom lens. The connections between these units have been omitted from FIG. 1, in order to increase the intelligibility of the drawing.

Furthermore, the processing unit is adapted to detect the pressing of the trigger unit TU and as a result instruct the control unit CU to either switch the state of the image capturing device 100 to camera mode, to perform an auto focus function on the image seen in the display unit DU or to instruct the sensing unit SU to capture the data registered by it when in camera mode.

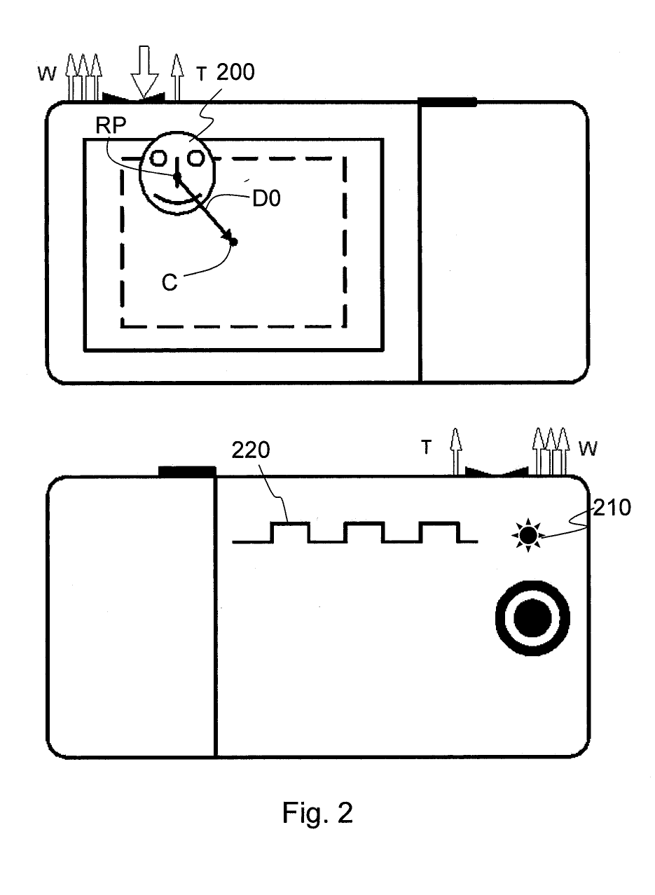

FIG. 2 shows the situation when a user of the image capturing device is attempting to make a auto portrait photograph. Previously known image capturing devices or mobile terminals with an image capturing function cannot on their own decide when a user wanting to make a auto portrait photograph or a portrait photograph of himself and other objects or people, is within the preferred area PA of the display unit DU, how much of the preferred area PA that objects fills and much less to give continuous feedback to the user about it.

In the situation in FIG. 2 we assume that the display unit DU of the image capturing device 100 according to the present invention is in camera mode and that a part of a face 200 (being the user's face) has been detected by the processing unit CPU in the preferred area PA of the image capturing device 100.

In order to locate the presence of a face, the processing unit CPU receives data from the sensing unit SU and applies face recognition algorithms on it. These face recognition algorithms are known in the art and will not be elaborated further.

In the example shown in FIG. 2, the processing unit CPU is also adapted to select a reference point R_{P} on the face recognized 200, such as the point 250 in the middle of the face 200. By means of the reference point R_{P}, the processing unit may calculate the distance D_{N} to a point in the preferred area PA, such as the center point C. Here, N stands for the n-th measurement cycle, where N is an integer starts from 0. It will be appreciated here that the most suitable distance between the reference point R_{P} and the center point C is a straight line connecting them, as depicted in FIG. 1.

Moreover, the processing unit CPU of the image capturing device 100 according to the present invention is also able to calculate the area of the user's face overlapping with the preferred area PA and compare it to the area of the user's face by calculating the ratio Q_{N} of these two values. Using this data, the processing unit CPU is able to calculate not only whether the face of the user who is taking an auto-portrait photograph is centered in the preferred area PA, but also if the size of the user's face in the preferred area PA is large enough.

The processing unit CPU may be adapted calculate a criterion for a satisfactory auto portrait ready to be taken by the user by using the following calculation.

This criterion may be characterized by the relations 0<D_{N}<D_{T}, D_{T}˜0 and Q_{T}<Q_{N}<1. Here, D_{T} is the upper threshold value for the distance between a reference point R_{P} on the face of the user in the preferred area and the center point C of the preferred area. If the distance D_{N} is located in the interval above this is accepted by the processing unit CPU as a sufficiently centered user's face. D_{T} is chosen to be close to zero but not equal to zero due to the difficulty for a user to manually position his face completely centered in the preferred area. Q_{T} is the lower threshold of Q_{N} resulting in a centered auto portrait of acceptable size which does not swell out of the preferred area PA. Q_{T} may be advantageously chosen to lie in the interval 0.9-0.99. Q_{T} may either be predefined or user-definable. The index N stands for the n-th measurement of the two parameters. Choosing values such as 0.9 as the lower limit of Q and setting the upper limit <1 safeguards that most of the user's face will be within the preferred area PA of the display unit DU and that the user's face will not be too small even if it is sufficiently centered in the preferred area. On the other hand, selecting the interval above interval prevents the “swelling” of the users face out of the preferred area PA in those situations when the user's face is sufficiently centered in the preferred area PA, but too close to the lens unit.

The processing unit CPU may calculate the distance D_{N} between the reference point R_{P} on the user's face and the center point C of the preferred area PA in a known way. Therefore it is not explained more in detail. Regarding the ratio Q_{N}, the processing unit may calculate it according to the equation below:

Q=Aoverlap/Aface,

where Aoverlap is the overlap area between the face 200 of the user and the preferred region PA of the display unit DU and Aface the area of the user's face. Thus Aoverlap changes depending on how much of the user's face area overlaps with the preferred area PA, while Aface is assumed to remain constant.

Now, in order to let the user making the auto portrait be aware how far he is from being sufficiently centered and his face being “big enough” in the preferred area PA, the processing unit CPU is adapted to regularly instruct the control unit to let the feedback unit FU increase the frequency of the feedback signal which is perceivable by the user. This signal may be either optical, acoustic or both. It may even be tactile, by using the vibration function of the image capturing device—a function present in as good as all mobile terminals sold on the market.

In the embodiment in FIG. 2 the feedback unit FU is chosen to be a lamp 210 whose blinking frequency is dependent on the distance D_{N} of the center point of user's face from the center point of the preferred area PA and the ratio Q_{N} between the overlap area between the user's face and the preferred area PA and the area of the user's face. The blinking signal from the lamp 210 is schematically illustrated as a square wave 220 in FIG. 2. However, it may be appreciated that the blinking signal 220 may be any other waveform as long as the signal has maxima and minima.

After every calculation of the two parameters above, i.e. D_{N} and Q_{N}, the processing unit CPU is adapted to instruct the control unit CU to let the blinking frequency of the lamp 210 vary in depending on how close or how far these two values are from the criterion 0<D_{N}<D_{T} and Q_{T}<Q_{N}<1.

The closer a reference point R_{P} on the user's face is to the center point C and the closer Q_{N} is to the predefined interval the more the control unit CU will increase the blinking frequency of the lamp in FIG. 2. The will indicate to the user making the auto portrait that his face is nearing the situation where a auto portrait would be ideal, ie. sufficiently centered in the preferred area PA and also filling a large part of the preferred are without his face “swelling out” of the preferred area.

On the other hand, the further away from the reference point R_{P} on the user's face is from the center point C of the preferred area PA and the further away Q_{N} is from the predefined interval, the more the control unit CU will lower the blinking frequency of the lamp. This the user making the auto portrait will interpret as going further away from an ideal auto portrait situation.

However, in case both criterions D_{N} and Q_{N} are fulfilled, i.e. 0<D_{N}<D_{T} and Q_{T}<Q_{N}<1 the processing unit CPU will instruct the control unit to simply let the lamp be turned and stop the blinking. This will indicate to the user that the ideal situation for capturing an auto portrait photograph is achieved. The user may then press the trigger unit TU and capture the auto portrait.

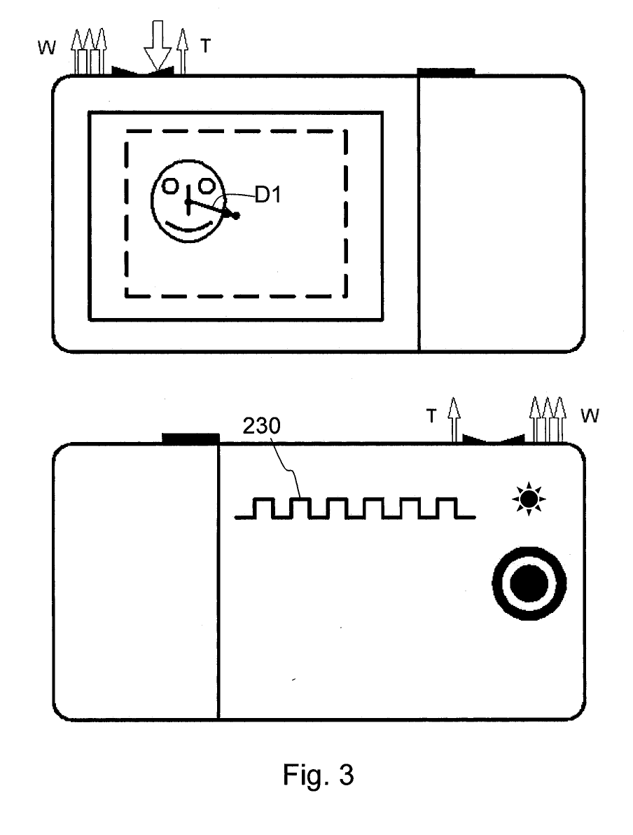

FIG. 3 show a situation when the reference point R_{P} on the user's face 200 is nearing the center point C. It is apparent from the figure that the user has not used the zoom unit ZU in order to attempt to zoom in his face in the preferred area. After calculating the new distance D₁ and the new ratio Q₁ (assuming that the distance and ratio calculated in FIG. 1 are D₁ and Q₁) the processing unit CPU will discover that the user's face has come close to the center point C of the preferred area PA and that the area of the user's face covering the preferred area PA has not changed.

This will result in the processing unit CPU instructing the control unit CU to increase the blinking frequency of the lamp 210 as is shown through the signal 230 in the figure.

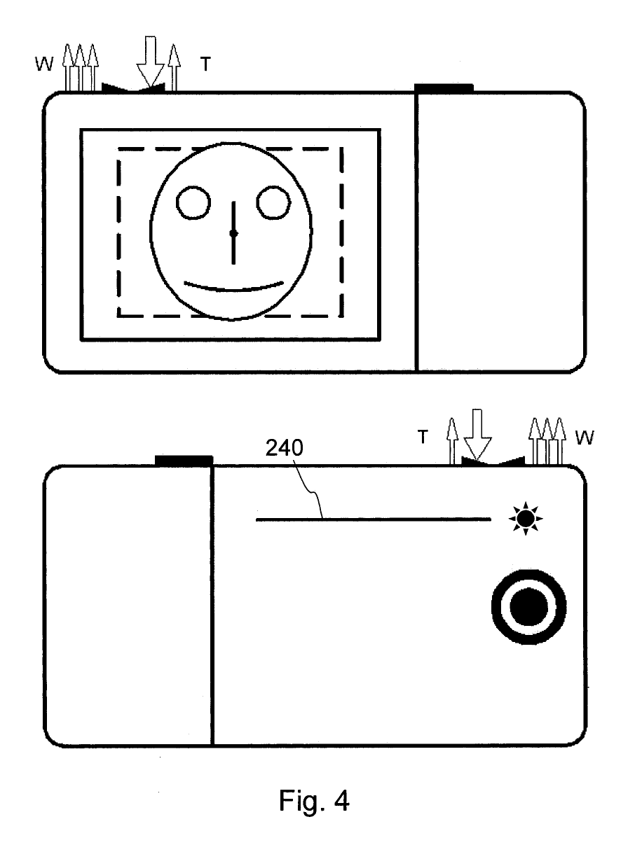

FIG. 4 illustrates the situation when the user has moved the image capturing device 100 into a position where his face is sufficiently centered, i.e. where 0<D₂<D_{T} and where the ration between the overlap area of the user's face and the preferred area PA and the area of the user's face is within the prescribed interval, i.e.

Q_{T}<Q₂<1.

In this situation, the processing unit CPU has calculated 0<D₂<D_{T} and Q_{T}<Q₂<1 and instructs the control unit CU to let the lamp be on without blinking.

This is indicated by the flat signal 240 in FIG. 4. In this situation the user can press on the trigger unit TU and capture the auto portrait photograph of ideal size.

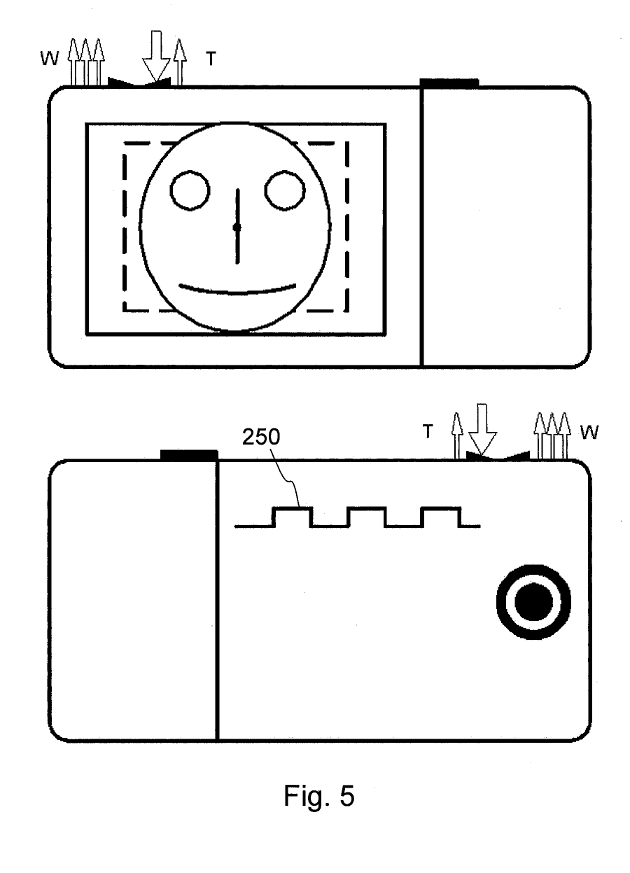

FIG. 5 illustrates the situation in which the user's face is sufficiently centered but where the ratio between the overlap area between his face and the preferred area PA is greater that the area of his face. This would correspond to the situation where 0<D4<D_{T} and Q4<Q_{T}.

The processing unit CPU is adapted to instruct the control unit to increase the blinking frequency of the lamp again in this case indicating to the user that he is moving further away from the desired auto portrait photograph again. This is indicated by the signal 250 in FIG. 5

It may be noted here that the embodiment of the present invention depicted in FIGS. 1-5 is only one example embodiment of the invention and should be interpreted as limiting the present invention to that embodiment only. For example, the image capturing device 100 according to the present invention may also implement a processing unit CPU instructing the control unit CU to make the lamp produce a blinking signal of increasing frequency when the user's face moves further away from the desired auto portrait situation and s blinking signal of decreasing frequency when the user's face moves closer to the desired auto portrait situation.

Also, the processing unit CPU may instruct the control unit CU to switch off the lamp when it detects that the desired auto portrait situation has been reached.

It may also be added that the image capturing device in FIGS. 1-4 may comprise more than one feedback unit, where one feedback unit may give feedback in relation to how close D_{N} is to the interval 0<D_{N}<D_{T}, i.e. whether the face of the user is sufficiently centered in relation to the preferred area. The other feedback unit may give feedback in relation to how close Q_{N} is to the interval Q_{T}<Q_{N}<1, i.e. how close to the desired size the user's face is.

Furthermore it may be mentioned that the present invention is not only limited to auto portrait situations where only one user is present. The present invention may equally be applied to the situation when a auto portrait is to be taken of a group of people, where the faces of all people should fulfil the criteria for a desired auto portrait situation, such as sum of D_{N,P}/P<=0.75D_{C,E} and the sum of Q_{T,P}/P<Q_{N,P}/P<=1, where D_{N,P} is the distance between each reference point on each face recognized in the preferred area PA, D_{C,E} the distance between the center point C of the preferred area PA and an edge of the preferred area PA. Furthermore Q_{T,P} and Q_{N,P} stand for the Q_{N} ratios and Q_{T} threshold values for each face detected in the preferred area PA.

This principle may also be applied to combinations of faces and objects having somewhat geometrical shapes, such as essentially circular, triangular, rectangular, square-shaped objects and objects of other types.

Lastly, it may also be mentioned that the point chosen on the preferred area need not be the center point of the preferred area PA. It may equally be chosen to be one of the points indicated as circles in FIG. 2.

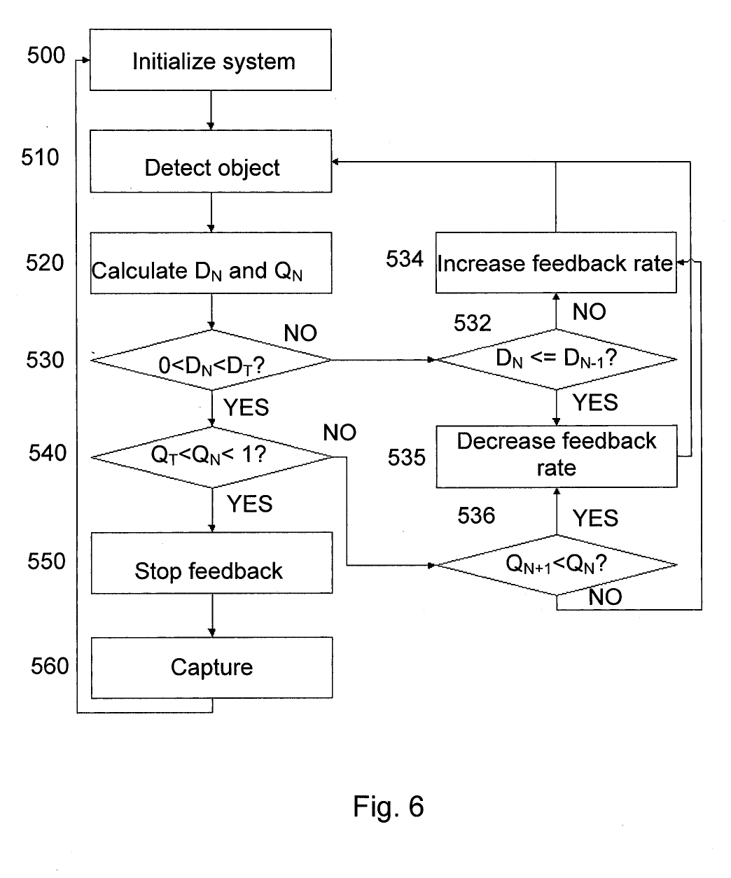

Now one embodiment of the method according to the present invention will be described with reference to the flow chart in FIG. 6 by using the embodiment of the image capturing device from FIG. 1

At step 500 the processing unit CPU of the image capturing device 100 initializes the variables of the camera system, by, for example, setting D_{N}=0 and Q_{N}=0 and switching of the lamp of the image capturing device 100.

At the next step 510, the processing unit CPU of the image capturing device 100 applies face and/or smile recognition algorithms on the data registered by the sensing unit SU of the image capturing device 100.

We assume here that the processing unit has detected at least a part of a face within the preferred area PA of the display unit DU of the image capturing device 100. It should be mentioned here, that the face and smile recognition algorithms may also detect the presence of more than one face in the preferred area. One may also add that the face recognition algorithms may also be enhanced so that they also recognize other objects besides human faces, such as having shapes resembling geometrical shapes, such as circles, triangles, rectangles, squares and others.

Next, at step 520, the variables D_{N} and Q_{N} are calculated by the processing unit. As mentioned earlier in the embodiments in FIGS. 1-5, D_{N} characterizes the distance of a reference point on the face recognized and a center point C of the preferred area and Q_{N} the ratio between the overlapping area between the face and the preferred area and the are of the face. The index n stands for the n-th measurement made by the processing unit CPU. In a first measurement, N=0.

At the next step 530 the processing unit checks whether the distance D_{N} between a reference point R_{P} on the face and the center point C of the preferred area is within the desired interval, i.e. whether 0<D_{N}<.D_{T}. If not, the processing unit CPU checks at step 532 whether the distance D_{N+1} measured is less than the distance D_{N} measured in the previous step. In a first measurement loop, D_{N} would be zero and D_{N+1} probably outside of the desired interval above.

In an optional step not shown in FIG. 6, the processing unit CPU may instruct control unit CU to send a command to the lens unit LU to zoom in the user's face. Preferably, the command from the control unit CU may instruct the lens unit LU to zoom in the user's face a predetermined amount. In case the lens unit LU only has fixed optics, the processing unit CPU may simply perform digital zoom on the user's face by a predetermined amount.

Step 532 serves the purpose of determining whether the face of the user recognized in the preferred area PA of the display unit DU is nearing or distancing itself from the center point C of the preferred area.

In case D_{N+1} is less than D_{N} it is an indication that the user's face is nearing the center point C of the preferred area, which will result in the processing unit CPU instructing the control unit CU to increase the blinking frequency of the lamp in the image capturing device 100 at step 534. Thereafter, the processing unit CPU performs face detection algorithms on the user's face again and executes step 520-530 again.

However, in case the distance D_{N} is within the interval 0<D_{N}<D_{T}, the processing unit CPU will treat that fact as the user's face being sufficiently centered in the preferred area PA and execute the next step 540 where it checks whether the ratio Q_{N} is in the desired interval, i.e. whether Q_{T}<Q_{N}<1. This situation would correspond to the case when the center of the user's face is sufficiently near the center of the preferred area and where the overlapping area between the user's face and the preferred area PA is less than the area of the user's face. The threshold criterion Q_{T} defines small the overlapping area between the user's face and the preferred area PA must be in order to be acceptable for a desired auto portrait photograph. It would be advantageous to set Q_{T} to be in the interval 0.9-0.95 such that essentially the entire face of the user is located within the preferred area PA without appearing too small.

In case Q_{N} is outside the desired interval, the processing unit compares the ratio Q_{N+1} of the present measurement to the ratio Q_{N} from a previous measurement at step 536. During a first measurement loop, Q_{N}=0 and Q_{N+1} greater than Q_{N}.

Now, in case the ratio from the present measurement Q_{N+1} is greater than the ration Q_{N} from the previous measurement, the processing unit CPU instructs the control unit CU to decrease the blinking frequency of the lamp in the image capturing unit indicating to the user that he is moving away from the desired auto portrait situation. This may, for example be the result of the user using the zoom unit ZU of the image capturing device 100, such that his face swells out of the preferred area. After step 535, the processing unit CPU returns to step 520 to perform face recognition algorithms again.

However, in case the present value of the ratio Q_{N+1} is lower than the previous ratio value Q_{N}, the processing unit CPU instructs the control unit CU to increase the blinking frequency of the lamp indicating to the user that the size of his face in the preferred area PA is nearing the desired criterion. It may also be added, that although not depicted in the flow chart in FIG. 6, the processing unit CPU will not instruct the CU to change the blinking frequency of the lamp in the image capturing device 100 if the ratio Q_{N+1}=Q_{N}. In this case, the processing unit CPU will simply directly return to a new face detection step at 520.

On the other hand, if the processing unit CPU has at step 540 determined that Q_{N+1} is within the desired range at step 540 it instructs the control unit CU to stop the blinking of the lamp signalling to the user making the auto portrait photograph that he may make his auto portrait. In the next step, the user presses the trigger unit TU and captures at step 560 a auto portrait of himself.

It may be mentioned here that the user may also select in the menu structure of the image capturing device 100 that the capturing of the auto portrait may be automatic. Then, step 560 would be automatically executed by the processing unit by storing the data supplied by the sensing unit SU in an external or internal memory of the image capturing device 100.

The present invention may also include software code which may implement the method steps 500-560 as presented in FIG. 5. Such a software code may either run in the internal memory of the image capturing device 100 or on an external memory of the same.

It will be appreciated that a skilled person having studied the disclosure above will contemplate various other embodiments of the image device according to the present invention or the method according to the present invention without departing from the scope and spirit of the present invention. Ultimately, the scope of the present invention is only limited by the accompanying patent claims.

1. Method for image capturing by means of an electronic device comprising the steps:
registering at least a part of an object to be positioned within a preferred area;
determining the position and the size of the object registered in relation to the preferred area;
producing feedback to a user of the electronic device in relation to the position and size of the object determined in relation to the preferred area;
adjusting the feedback to the user in relation to the change in position and size of the object with respect to the preferred area;
producing a signal to the user indicating that the object is within the preferred area and has the position and size required in relation to the preferred area and;
capturing an image of the object thus located.

2. Method according to claim 1, further comprising the steps of:
detecting predefined features of the object
selecting a reference point within the predefined features and;
determining the distance between the reference point and a point in the preferred area.

3. Method according to claim 1, wherein the preferred area is user selectable.

4. Method according to claim 1, wherein the position of the object required in relation to the preferred area is the position where the distance between the reference point of the object and a centre point of the preferred is located within a predefined interval.

5. Method according to claim 1, wherein the position of the object required in relation to the preferred area is the position where the distance between the reference point of the object and a reference point of the preferred area is located within a predefined interval.

6. Method according to claim 1, wherein the required size of the object in relation to the preferred area comprises a ratio between the overlapping area between the object and the preferred area and the area of the object itself being located in a predefined interval.

7. Method according to claim 1, wherein the signal is produced when essentially the entire object is located within the preferred area.

8. Method according to claim 1, wherein the signal is produced when a predetermined size of the entire object is located within the preferred area.

9. Method according to claim 1, wherein the object comprises a face of the user of the electronic device.

10. Method according to claim 1, wherein the object comprises a number of human faces of which one is the face of the user of the electronic device.

11. Electronic image capturing device comprising:
a processing unit adapted for registering the presence of at least part of an object in a preferred area on the image capturing device, the processing unit further being adapted for determining the position and size of the object registered in relation to the preferred area,
at least one indicator for producing feedback to a user of the electronic device depending on the position and size of the object registered in relation to the preferred area;
a control unit for instructing the indicator to produce feedback to a user of the electronic device in relation to the position and size object of the object registered with respect to the preferred area, the control unit being further adapted to instruct the indicator to adjust the feedback in relation to the change in position and size of the object in relation to the preferred area,
wherein the control unit is further adapted to instruct the indicator to produce a signal to the user indicative of the object having a required position and size in relation to the preferred area.

12. Electronic device according to claim 11, further comprising a user interface for adjusting the size of the preferred area.

13. Electronic device according to claim 11, wherein the indicator comprises an optical signal, an acoustic signal or a tactile signal.

14. Computer program product for image capturing by means of an electronic device, comprising instructions sets for:
registering at least a part of an object to be positioned within a preferred area;
determining the position and the size of the object registered in relation to the preferred area;
producing feedback to a user of the electronic device in relation to the position and size of the object in relation to the preferred area;
adjusting the feedback in relation to the change in position and size of the object with respect to the preferred area;
producing a signal to the user indicating that the object is within the preferred area and has the position and size required in relation to the preferred area and;
capturing an image of the object thus located.
